(19) United States
(12) Patent Application Publication
(10) Pub. No.: US 2026/0197920 A1
(43) Pub. Date: Jul. 9, 2026

(54) System and Corresponding Methods for Personalizing Car Ambient Lighting as a Function of Passenger Information

(71) Applicant: Motorola Mobility LLC, Chicago, IL (US)

(72) Inventors: Amit Kumar Agrawal, Bangalore (IN); Manas Ranjan, Delhi (IN); Shuaib Puzhakkal Kavalathara, Tirur (IN)

(21) Appl. No.: 19/013,967

(22) Filed: Jan. 8, 2025

(51) Int. Cl. H05B 47/125; B60Q 3/70

(52) U.S. Cl. CPC H05B 47/125; B60Q 3/70

(57) ABSTRACT

A system and method for personalizing car ambient lighting based on passenger attire includes an engine, an interior passenger-facing image capture device, an ambient lighting system, and one or more processors. The processors detect when the engine is operational, and a passenger is within the field of view of the image capture device. The image capture device captures images of the passenger's attire. The processors then adjust the ambient lighting characteristics, such as color, brightness, animation style, speed, and duration, based on the visual characteristics of the attire. The system can handle multiple passengers, adjusting the lighting for each passenger's attire and projecting different lighting characteristics to different areas of the vehicle interior. The lighting can return to a default state when the passenger's attire is no longer detected.

### BACKGROUND

### TECHNICAL FIELD

This disclosure relates generally to vehicles, and more particularly to vehicles with adjustable lighting systems.

### BACKGROUND ART

Vehicular interior lighting systems enhance the atmosphere and aesthetics of vehicles. These systems highlight design elements, increase visibility of controls, and provide a soothing ambience during nighttime drives. Current methods for adjusting car interior lighting involve manual controls, mobile applications, or sensors that respond to music beats. It would be advantageous to have improved systems offering more dynamic personalization of a vehicular environment without manual intervention.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory method in accordance with one or more embodiments of the disclosure.

FIG. 2 illustrates an explanatory system in accordance with one or more embodiments of the disclosure.

FIG. 3 illustrates one or more method steps in accordance with one or more embodiments of the disclosure.

FIG. 4 illustrates another explanatory system in accordance with one or more embodiments of the disclosure.

FIG. 5 illustrates one or more method steps in accordance with one or more embodiments of the disclosure.

FIG. 6 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to causing, by one or more processors in response to detecting an engine of the vehicular system is in operation with a passenger situated within a field of view of an image capture device, the image capture device to capture one or more images of the passenger and also causing, by the one or more processors, an ambient lighting system carried by the vehicular system to adjust a characteristic of output light as a function of a passenger garment depicted of the one or more images. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of, in response to the one or more processors detecting the engine is operational and a passenger is situated within a field of view of the interior causing the interior, passenger facing image capture device to capture one or more images of attire worn by the passenger and cause the ambient lighting system to adjust a presentation characteristic of output light emanating from the ambient lighting system as a function of the attire as described herein.

The non-processor circuits may include, but are not limited to, a radio receiver, a radio transmitter, signal drivers, clock circuits, power source circuits, and user input devices. As such, these functions may be interpreted as steps of a method to perform, in response to one or more processors determining that the vehicle is in a switched-ON state and is equipped with an interior facing camera, causing the interior facing camera to capture one or more images clothing worn by a passenger, determining, by the one or more processors from the one or more images, a visual characteristic associated with the clothing worn by the passenger, and causing, by the one or more processors, an ambient lighting system carried by the vehicle to adjust one or more output characteristics of output light as a function of the visual characteristic associated with the clothing.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure contemplate that vehicular interior lighting systems play a significant role in enhancing the atmosphere and aesthetics of vehicles. These systems highlight design elements, increase the visibility of controls, and provide a soothing ambience during nighttime drives. The ability to adjust the lighting within a vehicle's interior allows for a more personalized and comfortable driving experience.

Embodiments of the disclosure also contemplate that current methods for adjusting car interior lighting involve manual controls, mobile applications, or sensors that respond to music beats. These methods require user intervention and do not offer a high degree of automated personalization. Accordingly, current solutions for adjusting car ambient lighting present several limitations.

Manual controls necessitate the driver or passenger to physically interact with buttons or dials, which can be distracting and inconvenient, especially while driving. Mobile applications, while offering remote control capabilities, still require the user to navigate through various settings and options, which can be time-consuming and cumbersome. Sensors that respond to music beats provide a dynamic lighting experience but lack the ability to personalize the lighting based on the user's preferences or context. These methods do not account for the user's current appearance, mood, or location, resulting in a static and less engaging lighting experience.

To illustrate, consider the following use case examples: Imagine a person named Sarah drives towards a party, dressed in a pink outfit. As she prepares to take a quick selfie, she notices that the car's ambient lighting, previously set to green by her husband, clashes with her attire.

The green lighting does not complement her pink dress, creating an unappealing visual effect. Sarah faces the challenge of changing the lighting without interrupting her driving. Navigating through a series of settings and controls to adjust the lighting would distract her from the road, posing a safety risk.

Now imagine a person named Paul, who has had a long and tiring day at work and is driving home. The ambient lighting system in his car, controlled by an app, currently emits a blue light. This blue light, while soothing, makes Paul feel even more fatigued.

Paul desires a more energetic lighting environment to help him stay alert during his drive. However, he feels too exhausted to manually adjust the lighting settings through the app on his mobile device.

Now imagine a person named Jason, who loves taking his dog, Mac, on car rides. Mac, a loyal and affectionate companion, usually enjoys these trips, eagerly looking out the window and wagging his tail. However, Jason has noticed that Mac becomes visibly distressed whenever the car's ambient lighting turns red.

The red light seems to frighten Mac, causing him to whimper and hide under the seats. Jason wants to ensure that Mac feels comfortable and safe during their rides, but manually adjusting the lighting settings every time they get in the car is cumbersome and not always feasible.

Advantageously, embodiments of the disclosure address these problems by providing a dynamic and automated approach to personalizing car ambient lighting based on passenger information. In one or more embodiments, a system utilizes a combination of sensors, including a passenger-facing interior camera, GPS receiver, and day-night sensor, to continuously monitor and analyze the passenger's appearance, mood, and location. By capturing images of the passenger and detecting various contextual factors, the system determines the most suitable lighting characteristics, such as color, brightness, animation style, speed, and duration. This approach ensures that the ambient lighting within the vehicle is continuously tailored to the passenger's current state, enhancing the overall driving experience without requiring manual intervention

In one or more embodiments, the system determines that the car is in a switched-on state and is equipped with a passenger-facing interior camera, ambient lighting, GPS receiver, and a day-night sensor. The system can use various sensors to determine the current device and car contexts. These sensors include camera sensors to detect user appearance, such as clothes worn, and mood sensors to detect the passenger's emotional state.

In one or more embodiments, the system also uses a GPS receiver to detect the car's location and speed, and a day-night sensor to detect the brightness outside of the car. The camera can detect the passenger's facial expressions, appearance, and outfit color to determine the passenger's mood.

In one or more embodiments, the system then uses a combination of the available data to determine the most suitable color, combination of colors, brightness, animation style, animation speed, and animation duration for the ambient lighting. This determination ensures that the ambient lighting is suited for the current time frame and passenger context. In one or more embodiments, the system continuously repeats the above steps to provide a dynamic and personalized ambient lighting experience for the passenger. This continuous determination and adjustment of the ambient lighting advantageously enhances the overall driving experience by creating a personalized and comfortable environment within the vehicle.

Indeed, embodiments of the disclosure address Sarah's predicament by automating the personalization of the car's ambient lighting based on passenger information. Equipped with a passenger-facing interior camera, the system detects Sarah's appearance, including her pink dress.

The system then determines the most suitable lighting characteristics, such as color, brightness, and animation style, to match her outfit. Without requiring manual intervention, the system advantageously adjusts the ambient lighting to a color that complements Sarah's pink dress, enhancing her overall experience and allowing her to take a visually appealing selfie without compromising her safety.

What's more, embodiments of the disclosure address Paul's predicament by automating the personalization of the car's ambient lighting based on passenger information. Equipped with a passenger-facing interior camera, the system detects Paul's facial expressions and overall demeanor, recognizing signs of fatigue. The system then determines the most suitable lighting characteristics, such as color, brightness, and animation style, to energize Paul.

Advantageously, and without requiring manual intervention, the system adjusts the ambient lighting to a more stimulating color, such as a bright white or yellow, enhancing Paul's alertness and overall driving experience. This dynamic adjustment ensures that Paul remains attentive and safe during his drive home, without the need for him to interact with the app or any manual controls.

Embodiments of the disclosure also advantageously address Jason's concern by automating the personalization of the car's ambient lighting based on passenger information, including the presence of pets. Equipped with a passenger-facing interior camera, the system detects Mac's presence in the car. The system is programmed to recognize that red lighting causes distress to Max. Consequently, it automatically adjusts the ambient lighting to avoid red hues, opting for more soothing colors like blue or green that keep Mac calm and relaxed.

As Jason and Mac embark on their next car ride, the system ensures that the ambient lighting remains pet friendly. Mac, no longer frightened by the lighting, sits comfortably and enjoys the journey. Jason is relieved to see his furry friend at ease, knowing that the intelligent lighting system has taken care of Mac's needs without any manual intervention. This thoughtful adjustment enhances the overall experience for both Jason and Mac, making their car rides more enjoyable and stress-free.

While lighting can be controlled as a function of a variety of inputs, including a person's mood, current location, travel speed, whether it is day or night, facial expressions, or combinations thereof, some embodiments of the disclosure focus specifically on one input that particularly makes users happy, namely, attire. In one or more embodiments, a method in a vehicular system comprises causing, by one or more processors, in response to detecting that the engine of the vehicular system is in operation with a passenger situated within a field of view of an image capture device, the image capture device to capture one or more images of the passenger.

In one or more embodiments, the method further comprises causing, by the one or more processors, an ambient lighting system carried by the vehicular system to adjust a characteristic of output light as a function of a passenger garment depicted in the one or more images. The characteristic of the output light may include one or more of a color of the output light, a brightness of the output light, an animation style of the output light, an animation speed of the output light, and/or an animation duration for the output light. The method ensures that the ambient lighting within the vehicle is continuously tailored to the passenger's current state, enhancing the overall driving experience without requiring manual intervention.

Embodiments of a disclosure contemplate that using a person's attire or clothing to control the ambient lighting of a vehicle is significant because the system enhances the overall aesthetic and emotional experience of the passenger. The system captures images of the passenger's attire and adjusts the ambient lighting to complement the colors, patterns, and textures of the clothing.

This dynamic adjustment creates a visually harmonious environment that aligns with the passenger's personal style and preferences. By matching the lighting to the attire, the system fosters a sense of personalization and attention to detail, making the passenger feel valued and understood. Moreover, this approach to ambient lighting control can significantly impact the passenger's mood and comfort.

For instance, a passenger dressed in vibrant, energetic colors may benefit from similarly vibrant lighting that enhances their mood and creates a lively atmosphere. Conversely, a passenger wearing more subdued, calming colors may find that matching ambient lighting helps create a relaxing and soothing environment.

This alignment between attire and lighting can elevate the passenger's overall experience, making the journey more enjoyable and tailored to their current state. The ability to personalize the vehicle's interior lighting based on attire also adds an element of novelty and delight.

Passengers may feel a sense of joy and satisfaction when they see the lighting change to match their outfit, reinforcing their individuality and style. This feature can make routine car rides feel distinctive and contributing to a positive emotional response. By integrating such personalized elements, the system enhances the passenger's connection to the vehicle, making each journey a more pleasant and memorable experience.

In one or more embodiments, a vehicle comprises an engine, an interior, passenger-facing image capture device, an ambient lighting system, and one or more processors operable with the engine and operable to control the interior, passenger-facing image capture device and the ambient lighting system. In one or more embodiments, the one or more processors detect when the engine is operational, and a passenger is situated within a field of view of the interior.

In one or more embodiments, the one or more processors cause the interior, passenger-facing image capture device to capture one or more images of attire worn by the passenger. The one or more processors then cause the ambient lighting system to adjust a presentation characteristic of output light emanating from the ambient lighting system as a function of the attire.

In one or more embodiments, the presentation characteristic of the output light may include one or more of a color of the output light, a brightness of the output light, an animation style of the output light, an animation speed of the output light, and/or an animation duration for the output light. This system ensures that the ambient lighting within the vehicle is continuously tailored to the passenger's current state, enhancing the overall driving experience without requiring manual intervention.

Advantageously, this arrangement allows the system to detect when the engine is operational, and a passenger is within the field of view of the image capture device. The processors then cause the image capture device to capture images of the attire worn by the passenger.

Based on these images, the processors adjust the presentation characteristics of the ambient lighting, such as color, brightness, animation style, speed, and duration, to match or complement the attire. This setup ensures that the ambient lighting within the vehicle is continuously tailored to the passenger's current state, enhancing the overall driving experience without requiring manual intervention.

This dynamic adjustment creates a visually harmonious environment that aligns with the passenger's personal style and preferences, fostering a sense of personalization and attention to detail. Additionally, the system can handle multiple passengers, adjusting the lighting for each passenger's attire and projecting different lighting characteristics to different areas of the vehicle interior, thereby providing a customized and comfortable environment for all occupants.

In one or more embodiments, in response to one or more processors determining that the vehicle is in a switched-ON state and is equipped with an interior-facing camera, a method causes the interior-facing camera to capture one or more images of clothing worn by a passenger. The one or more processors then determine a visual characteristic associated with the clothing worn by the passenger from the one or more images.

The visual characteristic may include, but is not limited to, the pattern, texture, or cut of the clothing depicted in the images. The method further involves causing, by the one or more processors, an ambient lighting system carried by the vehicle to adjust one or more output characteristics of the output light as a function of the visual characteristic associated with the clothing.

The output characteristics of the light may include the color, brightness, animation style, animation speed, and animation duration. This adjustment ensures that the ambient lighting within the vehicle is continuously tailored to the passenger's current state, enhancing the overall driving experience without requiring manual intervention

Advantageously, this method allows for a highly personalized and dynamic adjustment of the vehicle's ambient lighting, enhancing the passenger's overall experience. By capturing images of the passenger's attire and analyzing visual characteristics such as patterns, textures, and cuts, the system can tailor the lighting to complement the passenger's clothing. This creates a visually harmonious environment that aligns with the passenger's personal style and preferences, fostering a sense of personalization and attention to detail.

The continuous adjustment of the ambient lighting based on real-time data from the camera ensures that the lighting remains relevant and suitable for the passenger's current state. This eliminates the need for manual intervention, making the process seamless and convenient for the passenger. Additionally, the system's ability to handle multiple passengers and adjust lighting for each individual's attire further enhances the comfort and personalization for all occupants in the vehicle.

For example, if a passenger is wearing a vibrant, patterned dress, the system can adjust the lighting to highlight and complement the colors and patterns of the dress, creating a lively and engaging atmosphere. Conversely, if another passenger is wearing a more subdued, textured outfit, the lighting can be adjusted to create a calming and soothing environment. This dynamic and context-aware approach to ambient lighting significantly improves the aesthetic and emotional experience within the vehicle, making each journey more enjoyable and tailored to the passengers'current states. Other advantages will be described below. Still others will be obvious to those of ordinary skill in the art having the benefit of this disclosure.

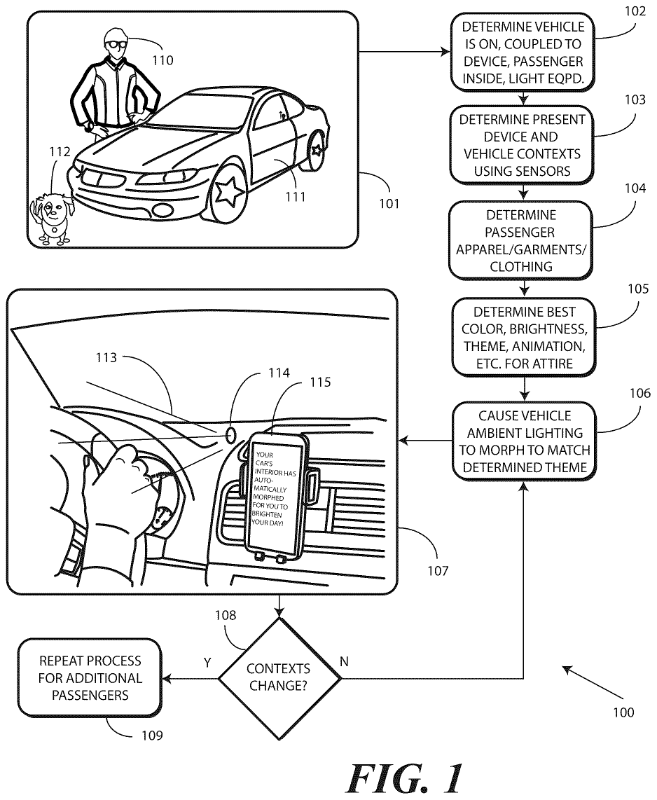

Turning now to FIG. 1, illustrated therein is one explanatory method 100 in accordance with one or more embodiments of the disclosure. At step 101 of FIG. 1, a person 110 and her dog 112 prepare for an exciting day out. They plan to visit a nearby park for a leisurely walk followed by a picnic.

The person 110, named Kayla, is particularly excited about this outing as this marks the first time, she and her dog 112, Buster, will explore this new park. Kayla has meticulously planned her attire to match the vibrant and sunny weather forecasted for the day.

She wears a bright yellow sundress made of lightweight cotton, which allows for breathability and comfort. The dress features a floral pattern with shades of pink and green, adding a touch of elegance and playfulness to her look. The dress has a fitted bodice that accentuates her waist, flowing into a flared skirt that moves gracefully with each step.

The sundress is complemented by a pair of white canvas sneakers, providing both style and practicality for walking on various terrains. Kayla also wears a wide-brimmed straw hat adorned with a matching yellow ribbon, offering protection from the sun while enhancing her overall ensemble. The hat's texture contrasts beautifully with the smooth cotton of her dress, creating a harmonious blend of materials.

To complete her outfit, Kayla carries a woven picnic basket, the natural fibers adding to the rustic charm of her look. Buster, her loyal companion, sports a new blue collar with a small silver tag engraved with his name. The collar's color contrasts nicely with his golden fur, making him look even more adorable.

As they approach the car 111, Kayla's excitement is palpable. She looks forward to the day's adventures, knowing that her carefully chosen attire will not only keep her comfortable but also make her feel confident and stylish. The combination of vibrant colors, thoughtful cuts, and varied textures in her garments reflects the joy and anticipation she feels for the day ahead.

At step 102, one or more processors of a vehicular system, which may be integrated into the vehicle or in a companion electronic device paired with the vehicle, one example of which includes a smartphone, determining that the car 111 is in a switched-ON state and is equipped with an interior facing camera. At step 103, the one or more processors cause the interior facing camera to capture one or more images clothing worn by a passenger, which in this example is Kayla.

At step 104, the one or more processors determine a visual characteristic associated with the clothing worn by the passenger. In one or more embodiments, step 104 of FIG. 1 involves the one or more processors determining a visual characteristic associated with the clothing worn by the passenger using one or more images captured of the passenger. This step can be achieved through various techniques, each offering distinct methods for analyzing the visual characteristics of the clothing. A few are described below. Others will be obvious to those of ordinary skill in the art having the benefit of this disclosure.

The processors can analyze the color of the clothing by examining the pixel values in the captured images. This involves identifying the dominant colors and their distribution across the garment.

The system can use color histograms to represent the distribution of colors in the image. By comparing these histograms to predefined color profiles, the system can determine the primary colors of the clothing.

This technique is straightforward and computationally efficient. The technique provides a quick way to identify the dominant colors, which can be used to adjust the ambient lighting to match or complement the clothing.

In other embodiments, the one or more processors can identify patterns on the clothing by analyzing the texture and repetitive elements in the images. The system can use texture analysis methods such as Gabor filters or Local Binary Patterns (LBP) to detect and classify patterns. These methods analyze the spatial distribution of pixel intensities to identify textures and patterns.

Pattern recognition allows for a more detailed understanding of the clothing's design. This can enable the system to create more sophisticated lighting effects that reflect the complexity of the garment's patterns.

In still other embodiments, the one or more processors can determine the shape and cut of the clothing by analyzing the contours and edges in the images. Edge detection algorithms, such as the Canny edge detector, can be used to identify the boundaries of the clothing. The system can then analyze these boundaries to determine the shape and cut of the garment.

Understanding the shape and cut of the clothing allows the system to tailor the lighting to enhance the visual appeal of the garment's silhouette. This can create a more immersive and aesthetically pleasing environment.

In still other embodiments, the one or more processors can analyze the texture of the clothing to determine the material properties, such as smoothness or roughness. The system can use texture descriptors, such as Gray Level Co-occurrence Matrix (GLCM) or Scale-Invariant Feature Transform (SIFT), to quantify the texture of the clothing. These descriptors capture the spatial relationships between pixels to characterize the texture.

Texture analysis provides insights into the material properties of the clothing, which can be used to adjust the lighting to highlight or complement the texture. This can enhance the tactile perception of the garment.

In still other embodiments, the one or more processors can use machine learning models to classify the clothing based on the visual characteristics of the clothing. The system can employ convolutional neural networks (CNNs) trained on a dataset of clothing images to classify the garment. The CNN can extract features from the images and use them to identify the type, color, pattern, and other characteristics of the clothing.

Machine learning-based classification offers high accuracy and can handle a wide variety of clothing styles and designs. The system can also adapt to new clothing trends by retraining the model with updated datasets.

In still other embodiments, the processors can analyze the passenger's facial expressions and contextual information to infer the appropriateness of the clothing for a specific occasion. The system can use facial recognition and emotion detection algorithms to analyze the passenger's expressions. By combining this information with the visual characteristics of the clothing, the system can infer the context, such as a formal event or a casual outing.

This technique provides a holistic understanding of the passenger's appearance and context, allowing the system to create a more personalized and contextually appropriate lighting environment. Each of these techniques offers advantages in determining the visual characteristics of the clothing worn by the passenger. By employing a combination of these methods, the system can achieve a comprehensive analysis, enabling dynamic and personalized adjustments to the ambient lighting within the vehicle. Of course, the techniques described above can be used alone or in combination.

At step 105, the one or more processors determine what the characteristic or characteristics of output light from the vehicular lighting system would be appropriate as a function of the passenger garment depicted in the one or more images captured at step 103. These characteristics can take any number of a variety of forms.

Illustrating by example, in one or more embodiments the visual characteristic associated with the clothing determined at step 105 comprises a pattern of the clothing depicted being worn by the passengers in the one or more images. In other embodiments, the visual characteristic associated with the clothing determined ats step 105 comprises a texture of the clothing depicted being worn by the passengers in the one or more images. In other embodiments, the visual characteristic associated with the clothing determined at step 105 comprises a cut of the clothing depicted being worn by the passengers in the one or more images. Of course, these characteristics are illustrative only, as others will be obvious to those of ordinary skill in the art having the benefit of this disclosure. Moreover, the characteristics can occur alone or in combination.

With these characteristics in mind, in one or more embodiments the characteristic of the output light comprises one or more of a color of the output light, a brightness of the output light, an animation style of the output light, an animation speed of the output light, and/or an animation duration for the output light. For example, in one or more embodiments the characteristic comprises the color of the output light and the color of the output light substantially matches another color of clothes depicted being worn by the passenger in the one or more images.

In other situations, the characteristic comprises an animation style of the light output, while the passenger garment comprises a multi-colored passenger garment. In one or more embodiments, when this is the case, the animation style causes a color of the light output to cycle temporally so as to match each color of the multi-colored passenger garment.

Illustrating by example, when the system captures images of Kayla's sundress, which features a floral pattern with shades of pink and green, the processors can analyze the visual characteristics of the dress, including the colors and patterns. Based on this analysis, the system determines that the most suitable characteristic for the ambient lighting is to cycle temporally between the shades of pink and green.

The animation style causes the color of the light output to transition smoothly between the pink and green hues, creating a dynamic and visually engaging environment within the car 111. This continuous cycling of colors enhances the aesthetic appeal of the vehicle's interior, making the vehicle's interior feel more vibrant and livelier. The interplay of pink and green light complements the floral pattern of Kayla's dress, creating a harmonious and cohesive visual experience.

As the ambient lighting cycles through the shades of pink and green, the lighting positively impacts Kayla's mood. The pink hues evoke feelings of warmth and comfort, while the green shades provide a sense of freshness and tranquility. This combination of colors creates a balanced and uplifting atmosphere, enhancing Kayla's overall driving experience. The dynamic lighting not only highlights her carefully chosen attire but also contributes to a more enjoyable and personalized journey.

In other embodiments, rather than matching the color of Kayla's dress, the presentation characteristic of the output light determined at step 105 comprises a color of the output light that is complementary to another color of the attire. Illustrating by example, at step 105 the one or more processors may select colors that are complementary to the shades of pink and green in Kayla's sundress. Complementary colors are sometimes considered to be those that are opposite each other on the color wheel, creating a high contrast and vibrant look when paired together.

For pink, the complementary color is green, and for green, the complementary color is red. However, to avoid using red, which may not be suitable for all passengers, the system can opt for variations such as teal or turquoise, which complement green, and soft peach or coral, which complement pink.

By selecting these complementary colors, the ambient lighting system can create a visually dynamic and engaging environment within the car 111. The teal or turquoise lighting will contrast beautifully with the green shades in Kayla's dress, while the soft peach or coral lighting will enhance the pink hues. This combination of colors will not only highlight the floral pattern of the dress but also create a balanced and aesthetically pleasing atmosphere.

The aesthetic effect of using complementary colors will have a positive impact on Kayla's mood. The vibrant contrast between the teal or turquoise and the soft peach or coral will create a lively and energetic ambiance, enhancing Kayla's overall driving experience. The dynamic lighting will make the vehicle's interior feel more vibrant and engaging, contributing to a sense of joy and excitement. This thoughtful adjustment of the ambient lighting will make Kayla feel valued and understood, reinforcing her individuality and style, and making her journey more enjoyable and memorable.

At step 106, the one or more processors cause an ambient lighting system carried by the vehicle to adjust one or more output characteristics of output light as a function of the visual characteristic associated with the clothing. At step 107 of FIG. 1, the ambient lighting system 114 carried by the car 111 adjusts one or more output characteristics of output light 113 as a function of Kayla's clothing.

In one illustrative embodiment, the system analyzes the captured images of Kayla's bright yellow sundress, adorned with floral patterns in shades of pink and green. The processors determine that the most suitable lighting characteristics involve a dynamic cycling of colors that complement and enhance the vibrant hues of her attire.

The ambient lighting system 114 transitions smoothly between soft pinks and fresh greens, creating a visually engaging and harmonious environment within the car. As the lighting adjusts, a coupled electronic device 115 presents a message indicating that the ambient lighting system has automatically morphed to brighten Kayla's day while ensuring her dog, Buster, is just as happy.

The message reassures Kayla that the system has taken into account her carefully chosen outfit and Buster's comfort, creating a personalized and delightful atmosphere. The interior of the car 111 transforms into an almost fairytale setting, with the gentle interplay of colors casting a magical glow.

The pink hues evoke feelings of warmth and comfort, while the green shades provide a sense of freshness and tranquility, making the journey feel enchanting and serene. Buster, nestled comfortably in the back seat, basks in the soothing light, his new blue collar gleaming softly against his white fur. The ambient lighting creates a calming effect, ensuring that Buster remains relaxed and content throughout the ride.

Kayla, feeling confident and stylish in her vibrant ensemble, enjoys the uplifting ambiance created by the dynamic lighting. The thoughtful adjustment of the ambient lighting enhances the overall experience for both Kayla and Buster, making their car ride a memorable and joyous adventure. The seamless integration of technology and personalization transforms the vehicle's interior into a captivating and enchanting space, reflecting the joy and anticipation of their day ahead.

Decision 108 determines whether the context of the vehicle changes, with step 109 repeating the process for new contexts. Illustrating by example, imagine that Kayla stops to pick up her nephew, Holden, en route. Rather than being one person in the car, there would be two. Steps 103,104,105,106,107 can repeat, with different results in one or more embodiments.

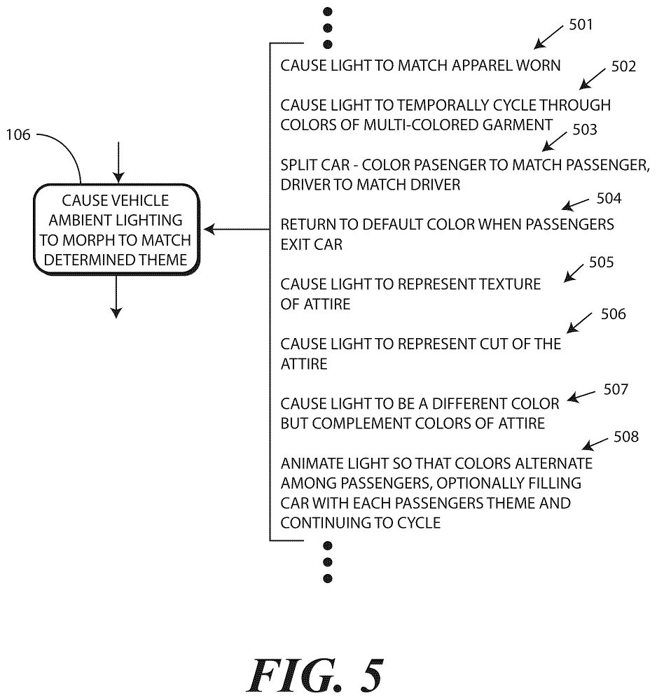

Illustrating by example, turning briefly to FIG. 5, illustrated therein are some ways in which step 106 can occur based upon differing contexts. These ways are illustrative only. Others will be obvious to those of ordinary skill in the art having the benefit of this disclosure.

As noted above, the characteristic of the output light controlled can comprise one or more of a color of the output light, a brightness of the output light, an animation style of the output light, an animation speed of the output light, and/or an animation duration for the output light. In one or more embodiments, the characteristic 501 comprises the color of the output light and the color of the output light substantially matches another color of clothes depicted being worn by the passenger in the one or more images.

In other embodiments, the characteristic 502 comprises an animation style of the light output. Accordingly, when the passenger garment comprises a multi-colored passenger garment, the animation style causes a color of the light output to cycle temporally so as to match each color of the multi-colored passenger garment in some embodiments.

In some embodiments, step 106 also causes the ambient lighting system to adjust the characteristic 503 of the output light as another function of another passenger garment depicted in the one or more images. When the passenger garment and the another passenger garment have different colors, the characteristic 503 can comprise the color of the output light and a first color of the output light substantially matches the passenger garment, and a second color of the output light substantially matches the another passenger garment. Step 106 can cause the first color of light to be directed toward a driver's seat of the vehicular system while the second color of light is directed toward a passenger's seat of the vehicular system.

Step 106 can comprise causing the light to return to a default color 504 when passengers exit the car. Step 106 can adjust the characteristic of the output light based upon texture 505 of the attire, a cut 506 of the attire, and so forth. The colors can be complementary 507 to the colors of the attire, as previously described.

For instance, when the system captures images of the passenger's attire using the interior, passenger-facing image capture device and the processors analyze the texture of the clothing depicted in the images, based on the identified texture, the processors determine the appropriate characteristics of the output light. If the attire has a smooth and shiny texture, the system may adjust the ambient lighting to have a higher brightness and a more reflective quality to complement the attire's sheen.

Conversely, if the attire has a rough or matte texture, the system may opt for softer, diffused lighting to enhance the tactile perception of the garment. The lighting characteristics, such as color, brightness, animation style, speed, and duration, are adjusted to create a visually harmonious environment that aligns with the texture of the attire. The system continuously monitors the passenger's attire and dynamically adjusts the ambient lighting to maintain a personalized and comfortable environment. This approach ensures that the lighting within the vehicle is tailored to the passenger's current state, enhancing the overall driving experience without requiring manual intervention. The ability to adjust the lighting based on the texture of the attire adds an element of novelty and delight, making routine car rides feel distinctive and contributing to a positive emotional response.

The processors can also analyze the images to determine the cut of the attire. The cut of the attire refers to the shape, style, and design of the garment, including elements such as the neckline, sleeves, hemline, and overall silhouette. The processors use edge detection algorithms, such as the Canny edge detector, to identify the boundaries and contours of the clothing. This analysis allows the system to understand the garment's structure and design.

Based on the determined cut of the attire, the processors adjust the characteristics of the output light from the ambient lighting system. For example, if the attire features a flowing, elegant design with soft lines and curves, the system may adjust the lighting to have a gentle, diffused quality that complements the garment's fluidity. The brightness may be set to a medium level, and the animation style may involve slow fades or transitions to create a serene and graceful atmosphere.

Conversely, if the attire has a sharp, tailored cut with defined edges and a structured silhouette, the system may opt for more focused and directional lighting. The brightness may be increased to highlight the garment's crisp lines, and the animation style may include quick pulses or sharp transitions to emphasize the attire's precision and formality. The lighting characteristics are continuously adjusted to maintain a visually harmonious environment that aligns with the cut of the attire, enhancing the passenger's overall experience.

In scenarios where multiple passengers are present, the system can adjust the lighting for each individual's attire. For instance, if one passenger is wearing a flowing dress and another is wearing a tailored suit, the system can project different lighting characteristics to different areas of the vehicle interior. The lighting near the passenger in the flowing dress may be soft and diffused, while the lighting near the passenger in the tailored suit may be sharp and focused. This dynamic adjustment ensures that the ambient lighting within the vehicle is personalized and comfortable for all occupants, creating a cohesive and aesthetically pleasing environment

Of course, the colors of attire of multiple passengers can be combined 508 as well. Indeed, the one or more processors can animate light so that colors alternate among passengers by utilizing a dynamic lighting control algorithm.

In one or more embodiments, this algorithm processes the visual characteristics of each passenger's attire and assigns a color theme to each passenger. The ambient lighting system then cycles through these themes, creating a visually engaging environment within the vehicle.

For instance, if one passenger is wearing a vibrant red dress and another passenger is wearing a cool blue suit, the system can alternate the ambient lighting between red and blue. The lighting can fill the entire car with each passenger's theme, ensuring that the colors blend seamlessly as they transition.

In one example, the system detects a passenger in the front seat wearing a green outfit and a passenger in the back seat wearing a yellow outfit. The processors can animate the lighting to alternate between green and yellow, filling the car with each color in a smooth, cyclical manner. The lighting can start with a green hue, gradually transitioning to yellow, and then back to green. This continuous cycle creates a dynamic and harmonious atmosphere, enhancing the visual appeal of the vehicle's interior.

Another example involves a scenario where the car is occupied by three passengers, each wearing different colored attire: one in red, one in blue, and one in purple. The processors can animate the lighting to cycle through red, blue, and purple, filling the car with each color theme in turn. The lighting can transition smoothly from one color to the next, ensuring that the interior remains visually balanced and engaging.

In one or more embodiments, the system can also adjust the brightness and animation speed to match the mood and context, such as using slower transitions for a relaxed atmosphere or faster transitions for a more energetic environment. In a more complex scenario, the system can detect multiple passengers with multi-colored attire.

For example, if one passenger is wearing a dress with shades of pink and green, and another passenger is wearing a shirt with blue and orange patterns, the processors can animate the lighting to cycle through pink, green, blue, and orange. The lighting can fill the car with each color in a sequence, creating a vibrant and dynamic environment. The animation style can include gradual fades, smooth transitions, or even pulsing effects to enhance the visual experience.

By continuously cycling through the color themes of each passenger, the system ensures that the ambient lighting remains dynamic and personalized. This approach not only enhances the aesthetic appeal of the vehicle's interior but also creates an enjoyable experience for passengers. The ability to animate light in this manner adds an element of novelty and delight, making each journey more memorable and tailored to the passengers'preferences.

Turning now back to FIG. 1, in one or more embodiments, the one or more processors can cause the ambient lighting system 114 to adjust the characteristic of the output light 113 not only as a function of Kayla's sundress, but also as another function of another passenger garment depicted in the one or more images, namely Holden's suit. If Holden is situated in the passenger seat and his suit is a deep navy blue, this would result in wherein the passenger garment and the another passenger garment have different colors.

Accordingly, the characteristic may comprise the color of the output light and a first color of the output light substantially matches the passenger garment, and a second color of the output light substantially matches the another passenger garment. The first color of light can be directed toward a driver's seat of the vehicular system and the second color of light is directed toward a passenger's seat of the vehicular system, and so forth.

Step 109 can also cause the color of the output light to return to a default color when the passenger garment fails to be depicted in the one or more images. Illustrating by example, if Kayla and Holden exit the car 111 for the party, the output light 113 of the ambient lighting system 114 may return to a default color.

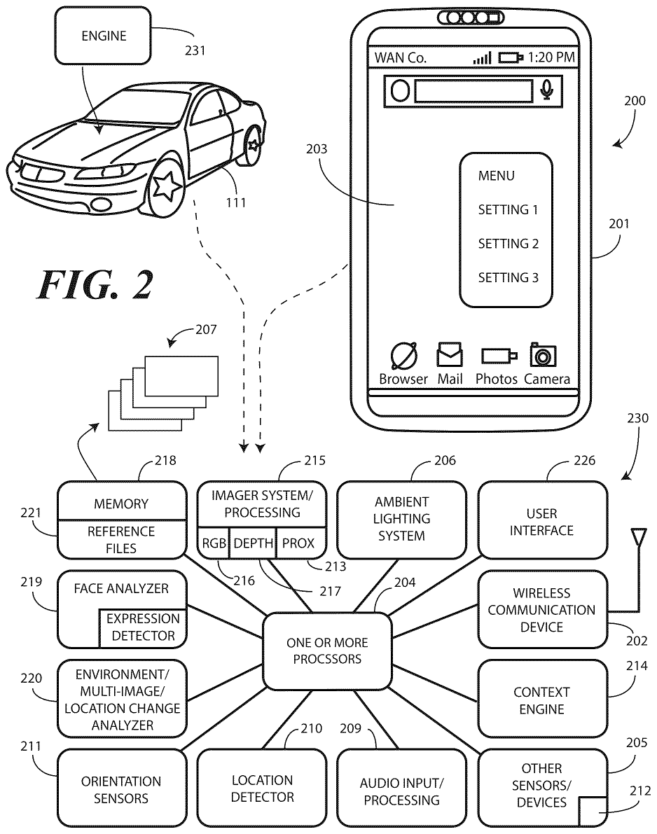

Turning now to FIG. 2, illustrated therein is one explanatory system configured in accordance with one or more embodiments of the disclosure. In FIG. 2, the system includes several components depicted in a block diagram schematic 230. These components can be integrated into a car 111 or into an electronic device 200 that is paired with the car 111.

It should be noted that the block diagram schematic 230 illustrates various components, including a user interface 226, one or more processors 204, a communication device 202, an audio input/processor 209, and several sensors 205, among others. The user interface 226 may include a display 203, which can be touch-sensitive, allowing users to interact with the system.

The one or more processors 204 can include an application processor and auxiliary processors, responsible for executing software code to perform the system's functions. The communication device 202 enables wired or wireless communication with other devices or networks, utilizing technologies such as Bluetooth, Wi-Fi, and cellular networks.

While the block diagram schematic 230 shows many components, some embodiments will use only a subset of these components. For instance, some systems will include only an image capture device 216 configured as an interior, passenger-facing image capture device, an ambient lighting system 206, and one or more processors 204 operable with the interior, passenger-facing image capture device and the ambient lighting system 206.

In one or more embodiments, the image capture device 216 captures images of the passenger, which the processors 204 analyze to determine visual characteristics of the passenger's attire. Based on this analysis, the ambient lighting system 206 adjusts the lighting characteristics, such as color, brightness, animation style, speed, and duration, to create a personalized and comfortable environment within the vehicle. This subset of components ensures that the system can dynamically and continuously tailor the ambient lighting to the passenger's current state without requiring manual intervention.

It should also be noted that the electronic device 200, while shown as a smartphone for illustrative purposes in FIG. 1 above, the electronic device 200 can be any of a number of various types of devices. For example, it should be obvious to those of ordinary skill in the art having the benefit of this disclosure that the block diagram schematic 230 could be used with other devices as well, including conventional desktop computers, palm-top computers, tablet computers, gaming devices, media players, wearable devices, or other devices. Still other devices will be obvious to those of ordinary skill in the art having the benefit of this disclosure.

In one or more embodiments, the block diagram schematic 230 is configured as a printed circuit board assembly disposed within a housing 201 of the electronic device 200 or car 111. Various components can be electrically coupled together by conductors, or a bus disposed along one or more printed circuit boards. Components of the electronic device 200 and car 111 can be in wireless communication to work cooperatively using a communication device 202.

The illustrative block diagram schematic 230 of FIG. 2 includes many different components. As noted above, embodiments of the disclosure contemplate that the number and arrangement of such components can change depending on the particular application. Accordingly, electronic devices configured in accordance with embodiments of the disclosure can include some components that are not shown in FIG. 2, and other components that are shown may not be needed and can therefore be omitted.

The illustrative block diagram schematic 230 includes a user interface 226. In one or more embodiments, the user interface 226 includes a display 203, which may optionally be touch sensitive. In one embodiment, users can deliver user input to the display 203 of such an embodiment by delivering touch input from a finger, stylus, or other objects disposed proximately with the display 203.

In one embodiment, the display 203 is configured as an active matrix organic light emitting diode (AMOLED) display. However, it should be noted that other types of displays, including liquid crystal displays, suitable for use with the user interface 226 would be obvious to those of ordinary skill in the art having the benefit of this disclosure.

In one embodiment, the electronic device includes one or more processors 204. In one embodiment, the one or more processors 204 can include an application processor and, optionally, one or more auxiliary processors.

One or both of the application processor or the auxiliary processor(s) can include one or more processors. One or both of the application processor or the auxiliary processor(s) can be a microprocessor, a group of processing components, one or more ASICs, programmable logic, or other type of processing device. The application processor and the auxiliary processor(s) can be operable with the various components of the block diagram schematic 230. Each of the application processor and the auxiliary processor(s) can be configured to process and execute executable software code to perform the various functions of the electronic device with which the block diagram schematic 230 operates. A storage device, such as memory 218, can optionally store the executable software code used by the one or more processors 204 during operation.

In this illustrative embodiment, the block diagram schematic 230 also includes a communication device 202 that can be configured for wired or wireless communication with one or more other devices or networks. The networks can include a wide area network, a local area network, and/or personal area network, or an ad hoc network with the car 111. The communication device 202 may also utilize wireless technology for communication, such as, but are not limited to, peer-to-peer or ad hoc communications such as HomeRF, Bluetooth, and IEEE 802.11, as well as other forms of wireless communication such as infrared technology. The communication device 202 can include wireless communication circuitry, one of a receiver, a transmitter, or transceiver, and one or more antennas.

In one embodiment, the one or more processors 204 can be responsible for performing the primary functions of the electronic device with which the block diagram schematic 230 is operational. For example, in one embodiment the one or more processors 204 comprise one or more circuits operable with the ambient lighting system 206. In one or more embodiments, the one or more processors 204 are operable with the engine 231 and operable to control the interior, passenger facing image capture device and the ambient lighting system 206.

In one or more embodiments, in response to the one or more processors 204 detecting the engine 231 is operational and a passenger is situated within a field of view of the interior, the one or more processors 204 cause the interior, passenger facing image capture device to capture one or more images of attire worn by the passenger. Thereafter, the one or more processors 204 can cause the ambient lighting system 206 to adjust a presentation characteristic of output light emanating from the ambient lighting system 206 as a function of the attire. The executable software code used by the one or more processors 204 can be configured as one or more modules 207 that are operable with the one or more processors 204. Such modules 207 can store instructions, control algorithms, and so forth.

In one or more embodiments, the block diagram schematic 230 includes an audio input/processor 209. The audio input/processor 209 can include hardware, executable code, and speech monitor executable code in one embodiment. The audio input/processor 209 can include, stored in memory 218, basic speech models, trained speech models, or other modules that are used by the audio input/processor 209 to receive and identify voice commands that are received with audio input captured by an audio capture device. In one embodiment, the audio input/processor 209 can include a voice recognition engine. Regardless of the specific implementation utilized in the various embodiments, the audio input/processor 209 can access various speech models to identify speech commands.

In one embodiment, the audio input/processor 209 is configured to implement a voice control feature that allows a user to speak a specific device command to cause the one or more processors 204 to execute a control operation. For example, the audio input/processor 209 may deliver a device command requesting the one or more processors 204 to cooperate with the authentication system to authenticate a user. Consequently, this device command can cause the one or more processors 204 to access the authentication system and begin the authentication process.

Various sensors 205 can be operable with the one or more processors 204. FIG. 2 illustrates several examples such sensors 205. It should be noted that those shown in FIG. 2 are not comprehensive, as others will be obvious to those of ordinary skill in the art having the benefit of this disclosure. Additionally, it should be noted that the various sensors 205 shown in FIG. 2 could be used alone or in combination. Accordingly, many electronic devices will employ only subsets of the sensors 205 shown in FIG. 2, with the particular subset defined by device application.

A first example of a sensor 205 that can be included with the other components is a touch sensor. The touch sensor can include a capacitive touch sensor, an infrared touch sensor, resistive touch sensors, or another touch-sensitive technology. Other types of touch sensors will be obvious to those of ordinary skill in the art having the benefit of this disclosure.

Another example of a sensor 205 is a geo-locator that serves as a location detector 210. In one embodiment, location detector 210 is able to determine location data when the electronic device 200 is moving in a vehicle, thereby informing the one or more processors 204 that the electronic device 200 is in a drive mode. This location data can be captured in a variety of ways, including by capturing the location data from a constellation of one or more earth orbiting satellites, or from a network of terrestrial base stations to determine an approximate location.

In one or more embodiments, the satellite positioning systems based location fixes of the location detector 210 autonomously or with assistance from terrestrial base stations, for example those associated with a cellular communication network or other ground based network, or as part of a Differential Global Positioning System (DGPS), as is well known by those having ordinary skill in the art. The location detector 210 may also be able to determine location by locating or triangulating terrestrial base stations of a traditional cellular network, or from other local area networks, such as Wi-Fi networks.

One or more motion detectors can be configured as orientation sensors 211 that determine an orientation and/or movement of the electronic device 200 in three-dimensional space. Illustrating by example, the orientation sensors 211 can include an accelerometer, gyroscopes, or other device to detect device orientation and/or motion of the electronic device 200. Using an accelerometer as an example, an accelerometer can be included to detect motion of the electronic device. Additionally, the accelerometer can be used to sense some of the gestures of the user, such as one talking with their hands, running, or walking.

The orientation sensors 211 can determine the spatial orientation of an electronic device 200 in three-dimensional space by, for example, detecting a gravitational direction. In addition to, or instead of, an accelerometer, an electronic compass can be included to detect the spatial orientation of the electronic device relative to the earth's magnetic field. Similarly, one or more gyroscopes can be included to detect rotational orientation of the electronic device 200.

The one or more sensors 205 can also include a gaze detector for detecting the user's gaze point. The gaze detector can optionally include sensors for detecting the alignment of a user's head in three-dimensional space. Electronic signals can then be processed for computing the direction of user's gaze in three-dimensional space. The gaze detector can further be configured to detect a gaze cone corresponding to the detected gaze direction, which is a field of view within which the user may easily see without diverting their eyes or head from the detected gaze direction. The gaze detector can be configured to alternately estimate gaze direction by inputting images representing a photograph of a selected area near or around the eyes. It will be clear to those of ordinary skill in the art having the benefit of this disclosure that these techniques are explanatory only, as other modes of detecting gaze direction can be substituted in the gaze detector of FIG. 2.

Other components 212 operable with the one or more processors 204 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker disposed behind a speaker port or other alarms and/or buzzers and/or a mechanical output component such as vibrating or motion-based mechanisms.

The other components 212 can also include proximity sensors 213. The proximity sensors 213 fall into one of two camps: active proximity sensors and “passive” proximity sensors. Either the proximity detector components or the proximity sensor components can be generally used for gesture control and other user interface protocols, some examples of which will be described in more detail below.

As used herein, a “proximity sensor component” comprises a signal receiver only that does not include a corresponding transmitter to emit signals for reflection off an object to the signal receiver. A signal receiver only can be used due to the fact that a user's body or other heat generating object external to device, such as a wearable electronic device worn by user, serves as the transmitter. Illustrating by example, in one the proximity sensor components comprise a signal receiver to receive signals from objects external to the housing 201 of the electronic device 200. In one embodiment, the signal receiver is an infrared signal receiver to receive an infrared emission from an object such as a human being when the human is proximately located with the electronic device 200.

Proximity sensor components are sometimes referred to as a “passive IR detectors” due to the fact that the person is the active transmitter. Accordingly, the proximity sensor component requires no transmitter since objects disposed external to the housing deliver emissions that are received by the infrared receiver. As no transmitter is required, each proximity sensor component can operate at a very low power level.

By contrast, proximity detector components include a signal emitter and a corresponding signal receiver. While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers.

In one or more embodiments, each proximity detector component can be an infrared proximity sensor set that uses a signal emitter that transmits a beam of infrared light that reflects from a nearby object and is received by a corresponding signal receiver. Proximity detector components can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals.

The other components 212 can optionally include a barometer or altimeter operable to sense changes in air pressure due to elevation changes or differing pressures of the electronic device 200. The other components 212 can also optionally include a light sensor that detects changes in optical intensity, color, light, or shadow in the environment of an electronic device. An infrared sensor can be used in conjunction with, or in place of, the light sensor. Similarly, the other components 212 can include a temperature sensor configured to monitor temperature about an electronic device 200.

A context engine 214 can then be operable with the various sensors to detect, infer, capture, and otherwise determine persons and actions that are occurring in an environment about the electronic device 200, including whether the engine 231 is operational a passenger and/or another passenger is situated within a field of view of the interior using an image capture device 216. In one or more embodiments, the one or more processors 204 cause the interior, passenger facing image capture device to capture one or more images of other attire worn by the passenger and/or the another passenger. In one or more embodiments, the one or more processors 204 cause the ambient lighting system 206 to adjust the presentation characteristic of some of the output light emanating from the ambient lighting system as a function of the attire of the passenger and the presentation characteristic of some other of the output light emanating from the ambient lighting system as a function of the other attire of the other passenger (where present).

In some embodiments, some of the output light is projected toward a first half of the interior and the some other of the output light is projected toward a second half of the interior. In some embodiments, the presentation characteristic further comprises a combination of an animation style of the output light, an animation speed of the output light, and an animation duration for the output light.

Where included one embodiment of the context engine 214 determines assessed contexts and frameworks using adjustable algorithms of context assessment employing information, data, and events. These assessments may be learned through repetitive data analysis. Alternatively, a user may employ the user interface 226 to enter various parameters, constructs, rules, and/or paradigms that instruct or otherwise guide the context engine 214. The context engine 214 can make such determinations by detecting multi-modal social cues, emotional states, moods, and other contextual information. The context engine 214 can comprise an artificial neural network or other similar technology in one or more embodiments.

In one or more embodiments, the context engine 214 is operable with the one or more processors 204. In some embodiments, the one or more processors 204 can control the context engine 214. In other embodiments, the context engine 214 can operate independently, delivering information gleaned from detecting multi-modal social cues, emotional states, moods, and other contextual information to the one or more processors 204. The context engine 214 can receive data from the various sensors. In one or more embodiments, the one or more processors 204 are configured to perform the operations of the context engine 214.

In one or more embodiments, the imager processor system 215 comprises an imager 216 that can be operable as an interior, passenger facing image capture device of the car 111. The imager processors system 215 can also include an optional depth imager 217, which can also be operable with an authentication system.

In one embodiment, the imager 216 comprises a two-dimensional imager configured to receive at least one image of a person within an environment of the electronic device 200. Illustrating by example, in one or more embodiments the imager 216 is configured as an image capture device operable to capture one or more images of one or more passengers of the car 111 and their attire. In one or more embodiments, the one or more processors 204 determine characteristics that can be used to control the ambient lighting system 206 when image analysis performed by the imager processors system 215 on one or more images of the passengers depict their clothing, garments, and/or attire.

In one embodiment, the imager 216 comprises a two-dimensional RGB imager. In another embodiment, the imager 216 comprises an infrared imager. Other types of imagers suitable for use as the imager 216 of the authentication system will be obvious to those of ordinary skill in the art having the benefit of this disclosure.

The depth imager 217, where included, can take a variety of forms. For example, the depth imager 217 can comprise a pair of imagers separated by a predetermined distance, such as three to four images. This “stereo” imager works in the same way the human eyes do in that it captures images from two different angles and reconciles the two to determine distance.

Alternatively, the depth imager 217 can comprise a structured light laser that projects tiny light patterns that expand with distance. These patterns land on a surface, such as a user's face, and are then captured by an imager. By determining the location and spacing between the elements of the pattern, three-dimensional mapping can be obtained.

In still another embodiment, the depth imager 217 comprises a time of flight device. Time of flight three-dimensional sensors emit laser or infrared pulses from a photodiode array. These pulses reflect back from a surface, such as the user's face. The time it takes for pulses to move from the photodiode array to the surface and back determines distance, from which a three-dimensional mapping of a surface can be obtained. Regardless of embodiment, where included the depth imager 217 adds detection of a third “z-dimension” to the x-dimension and y-dimension captured by the imager 216. This additional dimension can be used to enhance the security of using a person's face as authentication data, be it for use as their password in the process of authentication by facial recognition or for use as additional authorization to transmit media content when the one or more processors 204 prompt the person for the same.

In one or more embodiments, the authentication system can be operable with a face analyzer 219 and/or an environmental analyzer 220. The face analyzer 219 and/or environmental analyzer 220 can be configured to process an image or depth scan of an object and determine whether the object matches predetermined criteria, including whether an interest level of an authorized user exceeds a threshold.

For example, the face analyzer 219 and/or environmental analyzer 220 can operate as an identification module configured with optical and/or spatial recognition to identify objects using image recognition, character recognition, visual recognition, facial recognition, color recognition, shape recognition, and the like. Advantageously, the face analyzer 219 and/or environmental analyzer 220, operating in tandem with the authentication system, can be used as a facial recognition device to determine the identity of one or more persons detected about the electronic device 200.

In one or more embodiments, when the authentication system detects a person, one or both of the imager 216 and/or the depth imager 217 can capture a photograph and/or depth scan of that person. The authentication system can then compare the image and/or depth scan to one or more predefined authentication reference files 221 stored in the memory 218. This comparison, in one or more embodiments, is used to confirm beyond a threshold authenticity probability that the person's face - both in the image and the depth scan-sufficiently matches one or more of the reference files 221.

Beneficially, this optical recognition performed by the authentication system operating in conjunction with the face analyzer 219 and/or environmental analyzer 220 allows the one or more processors 204 to detect an interest level of an authorized user in a precis of a notification being presented by the user interface 226.

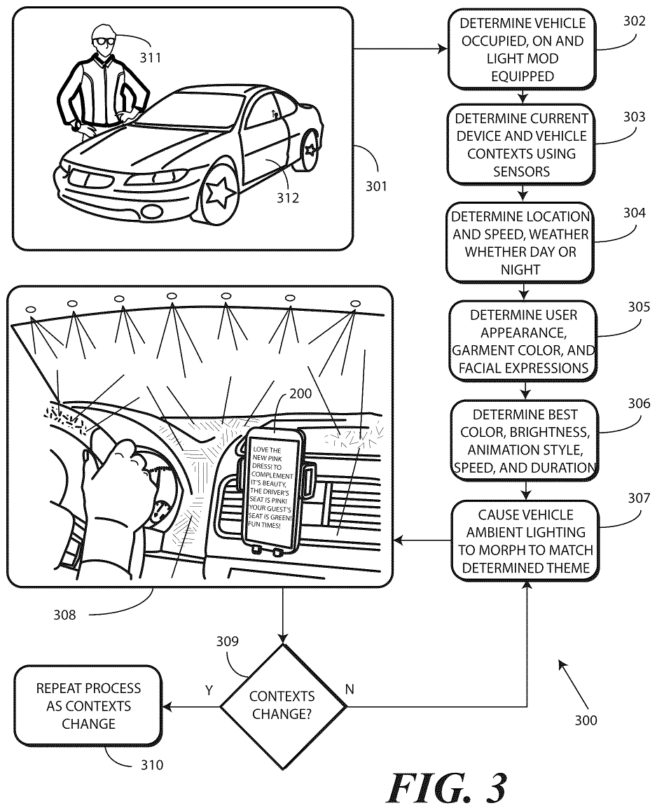

Turning now to FIG. 3, illustrated therein is one explanatory method 300 for using the electronic device 200 of FIG. 2, when paired with a vehicle 312, to control the ambient lighting system depicted at step 308. Beginning at step 301, a passenger 311 is entering a vehicle 312. At step 302, one or more processors of the electronic device 200 cause a communication device of the electronic device 200 to pair with the vehicular electronics system.

In one or more embodiments, the one or more processors of the electronic device 200 can use one or more sensors of the electronic device 200 to determine that the vehicle 312 is in a switched-ON state at step 302. Additionally, at step 302 the one or more processors of the electronic device 200 can determine whether the vehicle 312 is equipped with an interior, passenger facing image capture device. If not, the one or more processors can use the on-board image capture device of the electronic device 200 as the interior, passenger facing image capture device.

At step 303, the one or more processors cause, in response to detecting an engine of the vehicular system is in operation with a passenger is situated within a field of view of an image capture device, the image capture device to capture one or more images of the passenger. At step 304, the one or more processors can use one or more sensors to determine the speed of the vehicle 312, whether it is day or night, the location of the vehicle, and the weather about the vehicle 312.

At step 305, the one or more processors can use image analysis to determine passenger garments being depicted in the one or more images. Step 305 can also determine the appearance of the passenger, facial expressions of the passenger, and a mood of a passenger as well.

At step 306, the one or more processors can determine a color, brightness, animation style, animation speed, and animation duration for a vehicular lighting system as a function of one or more of the inputs determined at steps 304,305 as well.

Illustrating by example, at step 306 of FIG. 3, the one or more processors determine a color, brightness, animation style, animation speed, and animation duration for a vehicular lighting system as a function of a passenger garment depicted in one or more images, optionally combined with the speed of the vehicle, whether day or night, the location of the vehicle, and the weather about the vehicle. In one or more embodiments, the processors analyze the appearance of the passenger, facial expressions of the passenger, and the mood of the passenger to tailor the ambient lighting accordingly.

For example, if the passenger is wearing a vibrant, multi-colored dress and the vehicle is traveling at a moderate speed during the day, the processors may determine that a dynamic animation style with cycling colors that match the dress is appropriate at step 306. The brightness of the lighting may be set to a medium level to complement the daylight, and the animation speed may be moderate to create a lively yet not overwhelming atmosphere. The animation duration may be set to cycle through the colors every few seconds, ensuring a continuous and engaging visual experience.

In another scenario, if the passenger is wearing a dark, formal suit and the vehicle is traveling at a high speed during the night, the processors may determine at step 306 that a more subdued and steady lighting style is suitable. The color of the lighting may be set to a deep blue or soft white to match the formal attire and create a calming effect. The brightness may be set to a lower level to avoid glare and enhance night-time visibility. The animation style may be minimal, with slow transitions or no animation at all, to maintain a serene and focused environment.

If the passenger's facial expressions indicate fatigue and the mood sensors detect a low energy state, the processors may adjust the lighting to an energizing color such as bright white or yellow. The brightness may be increased to a higher level to stimulate alertness. The animation style may include quick pulses or flashes to invigorate the passenger. The animation speed may be faster, and the duration may be shorter to create a sense of urgency and wakefulness.

In a situation where the passenger appears relaxed and the mood sensors detect a calm state, the processors may choose a soothing color such as soft green or blue. The brightness may be set to a medium-low level to maintain a tranquil atmosphere. The animation style may involve gentle fades or slow transitions, with a slower animation speed and longer duration to sustain the calming effect. By continuously analyzing the passenger's appearance, facial expressions, and mood, the processors dynamically adjust the ambient lighting to enhance the passenger's comfort and overall experience, creating a personalized and responsive environment within the vehicle.

At step 307, the one or more processors cause the ambient lighting system, shown at step 308 with some light being directed toward the driver's seat and some other light being directed to the passenger's seat, in addition to a glowing dashboard that is able to change colors as well in addition to a steering wheel that emits light, cause this collective an ambient lighting system carried by the vehicular system to adjust a characteristic of output light as a function of a passenger garment depicted of the one or more images combined with one or more other optional factors. When the context changes, as determined by decision 309, step 310 can repeat the process as previously described.

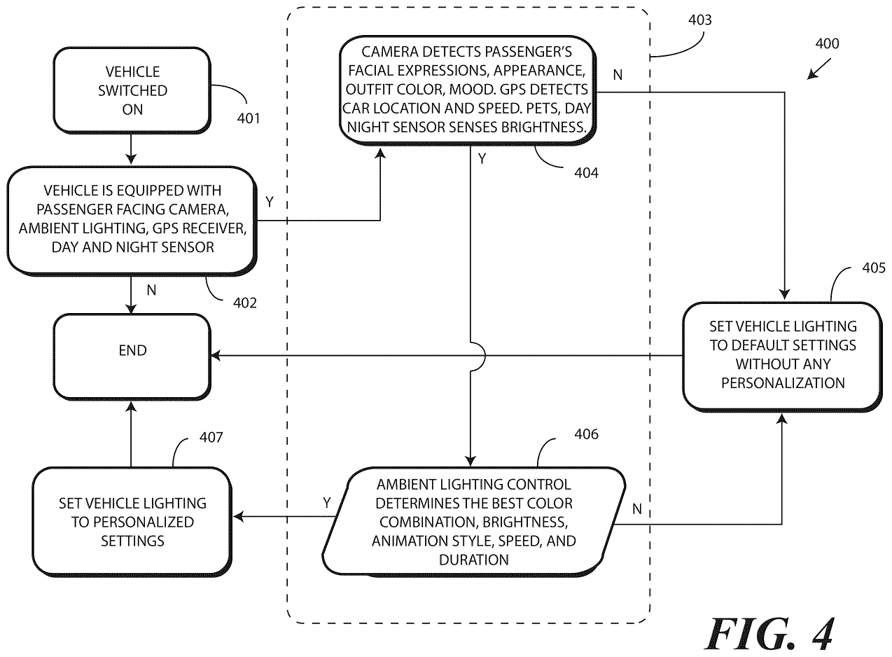

Turning now to FIG. 4, illustrated therein is another explanatory system 400 in accordance with one or more embodiments of the disclosure. The system 400 is configured for personalizing car ambient lighting based on passenger information. The system 400 can be implemented by a vehicle equipped with a passenger-facing camera, ambient lighting system, GPS receiver, and day-night sensors.

At step 401, the vehicle switches on. This step initiates the process by detecting that the vehicle is in an operational state.

At step 402, the system 400 determines whether the vehicle is equipped with a passenger-facing camera, ambient lighting system, GPS receiver, and day-night sensors. If the vehicle is not equipped with these components, the method ends.

Processor block 403 includes two steps, namely step 404 and step 406. At step 404, the camera detects the passenger's facial expressions, appearance, and outfit color. The GPS receiver calculates the car's location and speed, while the day-night sensors sense the brightness outside the vehicle.

At step 404, the method determines whether the vehicle lighting be set to default settings or personalized. If the lighting is set to default settings, the method proceeds to step 405. At step 405, the method sets the vehicle lighting to default settings. This step ensures that the ambient lighting is configured to a standard state when personalization is not required.

At step 406, the ambient lighting control determines the color, combination of colors, brightness, animation style, speed, and duration based on the passenger's information and contextual data. This step personalizes the ambient lighting to enhance the passenger's experience. At step 407, the method sets the vehicle lighting to the personalized settings determined in step 406. This step finalizes the process by adjusting the ambient lighting to match the passenger's current state and preferences.

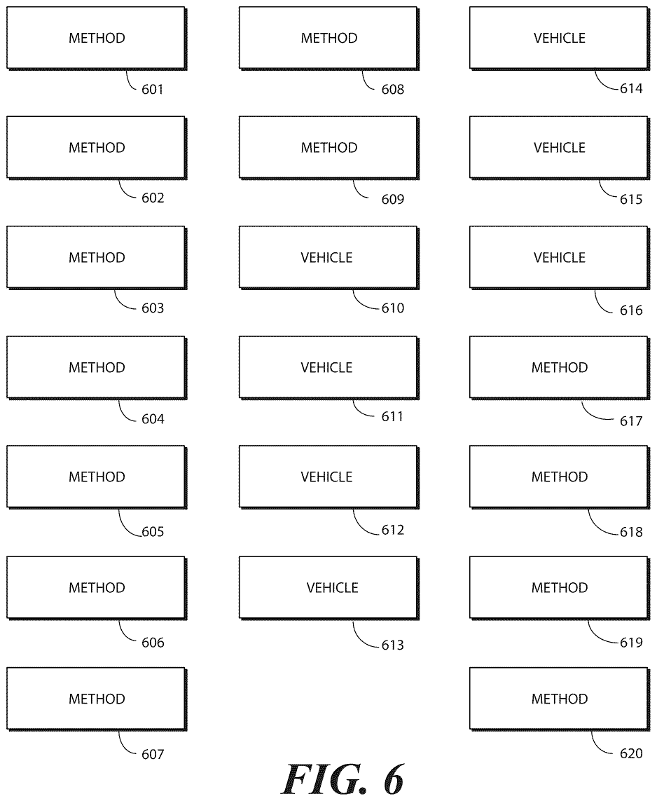

Turning now to FIG. 6, illustrated therein are various embodiments of the disclosure. The embodiments of FIG. 6 are shown as labeled boxes in FIG. 6 due to the fact that the individual components of these embodiments have been illustrated in detail in FIGS. 1-5, which precede FIG. 6. Accordingly, since these items have previously been illustrated and described, their repeated illustration is no longer essential for a proper understanding of these embodiments. Thus, the embodiments are shown as labeled boxes.

At 601, a method in a vehicular system comprises causing, by one or more processors in response to detecting an engine of the vehicular system is in operation with a passenger situated within a field of view of an image capture device, the image capture device to capture one or more images of the passenger. At 601, the method comprises also causing, by the one or more processors, an ambient lighting system carried by the vehicular system to adjust a characteristic of output light as a function of a passenger garment depicted of the one or more images.

At 602, the characteristic of the output light of 601 comprises one or more of a color of the output light, a brightness of the output light, an animation style of the output light, an animation speed of the output light, and/or an animation duration for the output light. At 603, the characteristic of 602 comprises the color of the output light and the color of the output light substantially matches another color of clothes depicted being worn by the passenger in the one or more images.

At 604, the characteristic of 602 comprises an animation style of the light output. At 604, the passenger garment comprises a multi-colored passenger garment. At 604, the animation style causes a color of the light output to cycle temporally so as to match each color of the multi-colored passenger garment.

At 605, the also causing of 602 comprises causing the ambient lighting system to adjust the characteristic of the output light as another function of another passenger garment depicted in the one or more images. At 606, the passenger garment of 605 and the another passenger garment have different colors.

At 607, the characteristic of 606 comprises the color of the output light and a first color of the output light substantially matches the passenger garment, and a second color of the output light substantially matches the another passenger garment. At 608, the first color of light of 607 is directed toward a driver's seat of the vehicular system and the second color of light is directed toward a passenger's seat of the vehicular system. At 609, the one or more processors of 602 cause the color of the output light to return to a default color when the passenger garment fails to be depicted in the one or more images.

At 610, a vehicle comprises an engine, an interior, passenger facing image capture device, an ambient lighting system, and one or more processors operable with the engine and operable to control the interior, passenger facing image capture device and the ambient lighting system. At 610, in response to the one or more processors detecting the engine is operational and a passenger is situated within a field of view of the interior, the one or more processors cause the interior, passenger facing image capture device to capture one or more images of attire worn by the passenger and cause the ambient lighting system to adjust a presentation characteristic of output light emanating from the ambient lighting system as a function of the attire.

At 611, the presentation characteristic of the output light of 610 comprises a color of the output light that is complementary to another color of the attire. At 612, the color of the output light of 611 and the another color are different. At 613, the another color of 611 comprises multiple colors and the color of the output light cycles temporally through the multiple colors.

At 614, in response to the one or more processors of 610 detecting the engine is operational and another passenger is situated within a field of view of the interior, the one or more processors cause the interior, passenger facing image capture device to capture one or more images of other attire worn by the another passenger. At 614, the one or more processors cause the ambient lighting system to adjust the presentation characteristic of some of the output light emanating from the ambient lighting system as a function of the attire and the presentation characteristic of some other of the output light emanating from the ambient lighting system as a function of the other attire.

At 615, the some of the output light of 614 is projected toward a first half of the interior and the some other of the output light is projected toward a second half of the interior. At 616, the presentation characteristic of 615 further comprises a combination of an animation style of the output light, an animation speed of the output light, and an animation duration for the output light.

At 617, a method in a vehicle comprises in response to one or more processors determining that the vehicle is in a switched-ON state and is equipped with an interior facing camera, causing the interior facing camera to capture one or more images clothing worn by a passenger. At 617, the method comprises determining, by the one or more processors from the one or more images, a visual characteristic associated with the clothing worn by the passenger. At 617, the method comprises causing, by the one or more processors, an ambient lighting system carried by the vehicle to adjust one or more output characteristics of output light as a function of the visual characteristic associated with the clothing.

At 618, the visual characteristic of 617 associated with the clothing comprises a pattern of the clothing depicted being worn by the passengers in the one or more images. At 619, the visual characteristic of 617 associated with the clothing comprises a texture of the clothing depicted being worn by the passengers in the one or more images. At 620, the visual characteristic of 617 associated with the clothing comprises a cut of the clothing depicted being worn by the passengers in the one or more images

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, in one embodiment, the vehicle system includes an engine, an interior passenger-facing image capture device, an ambient lighting system, and one or more processors operable with the engine and configured to control both the image capture device and the ambient lighting system. The processors detect when the engine is operational, and a passenger is within the field of view of the image capture device.

Upon detection, the image capture device captures images of the passenger's attire, and the processors adjust the ambient lighting characteristics based on the visual characteristics of the attire. This adjustment can include changes in color, brightness, animation style, speed, and duration of the lighting.

In another embodiment, the system can handle multiple passengers by capturing images of each passenger's attire and adjusting the lighting for different areas of the vehicle interior accordingly. For instance, the lighting near the driver can be adjusted to match the driver's attire, while the lighting near the passenger can be adjusted to match the passenger's attire.

Additionally, the system can return the lighting to a default state when the passenger's attire is no longer detected. In yet another embodiment, the system can use complementary colors to enhance the visual appeal of the vehicle's interior. For example, if a passenger is wearing a blue outfit, the system can adjust the lighting to a complementary color such as orange. The system can also cycle through multiple colors if the attire has multiple colors, creating a dynamic and engaging environment.

Furthermore, the system can incorporate additional sensors, such as GPS receivers and day-night sensors, to further personalize the lighting based on the vehicle's location, speed, and external lighting conditions. This ensures that the ambient lighting is continuously tailored to the passenger's current state and the vehicle's context, enhancing the overall driving experience without requiring manual intervention

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in a vehicular system, the method comprising:
causing, by one or more processors in response to detecting an engine of the vehicular system is in operation with a passenger situated within a field of view of an image capture device, the image capture device to capture one or more images of the passenger; and
also causing, by the one or more processors, an ambient lighting system carried by the vehicular system to adjust a characteristic of output light as a function of a passenger garment depicted of the one or more images.

2. The method of claim 1, wherein the characteristic of the output light comprises one or more of a color of the output light, a brightness of the output light, an animation style of the output light, an animation speed of the output light, and/or an animation duration for the output light.

3. The method of claim 2, wherein the characteristic comprises the color of the output light and the color of the output light substantially matches another color of clothes depicted being worn by the passenger in the one or more images.

4. The method of claim 2, wherein:
the characteristic comprises an animation style of the output light;
the passenger garment comprises a multi-colored passenger garment; and
the animation style causes a color of the output light to cycle temporally so as to match each color of the multi-colored passenger garment.

5. The method of claim 2, wherein the also causing comprises causing the ambient lighting system to adjust the characteristic of the output light as another function of another passenger garment depicted in the one or more images.

6. The method of claim 5, wherein the passenger garment and the another passenger garment have different colors.

7. The method of claim 6, wherein the characteristic comprises the color of the output light and a first color of the output light substantially matches the passenger garment, and a second color of the output light substantially matches the another passenger garment.

8. The method of claim 7, wherein the first color of light is directed toward a driver's seat of the vehicular system and the second color of light is directed toward a passenger's seat of the vehicular system.

9. The method of claim 2, wherein the one or more processors cause the color of the output light to return to a default color when the passenger garment fails to be depicted in the one or more images.

10. A vehicle, comprising:
an engine;
an interior, passenger facing image capture device;
an ambient lighting system; and
one or more processors operable with the engine and operable to control the interior, passenger facing image capture device and the ambient lighting system;
wherein, in response to the one or more processors detecting the engine is operational and a passenger is situated within a field of view of the interior, the one or more processors cause the interior, passenger facing image capture device to capture one or more images of attire worn by the passenger and cause the ambient lighting system to adjust a presentation characteristic of output light emanating from the ambient lighting system as a function of the attire.

11. The vehicle of claim 10, wherein the presentation characteristic of the output light comprises a color of the output light that is complementary to another color of the attire.

12. The vehicle of claim 11, wherein the color of the output light and the another color are different.

13. The vehicle of claim 11, wherein the another color comprises multiple colors and the color of the output light cycles temporally through the multiple colors.

14. The vehicle of claim 10, wherein in response to the one or more processors detecting the engine is operational and another passenger is situated within a field of view of the interior, the one or more processors cause the interior, passenger facing image capture device to capture one or more images of other attire worn by the another passenger and cause the ambient lighting system to adjust the presentation characteristic of some of the output light emanating from the ambient lighting system as a function of the attire and the presentation characteristic of some other of the output light emanating from the ambient lighting system as a function of the other attire.

15. The vehicle of claim 14, wherein the some of the output light is projected toward a first half of the interior and the some other of the output light is projected toward a second half of the interior.

16. The vehicle of claim 15, wherein the presentation characteristic further comprises a combination of an animation style of the output light, an animation speed of the output light, and an animation duration for the output light.

17. A method in a vehicle, the method comprising:
in response to one or more processors determining that the vehicle is in a switched-ON state and is equipped with an interior facing camera, causing the interior facing camera to capture one or more images clothing worn by a passenger;
determining, by the one or more processors from the one or more images, a visual characteristic associated with the clothing worn by the passenger; and
causing, by the one or more processors, an ambient lighting system carried by the vehicle to adjust one or more output characteristics of output light as a function of the visual characteristic associated with the clothing.

18. The method of claim 17, wherein the visual characteristic associated with the clothing comprises a pattern of the clothing depicted being worn by passengers in the one or more images.

19. The method of claim 17, wherein the visual characteristic associated with the clothing comprises a texture of the clothing depicted being worn by passengers in the one or more images.

20. The method of claim 17, wherein the visual characteristic associated with the clothing comprises a cut of the clothing depicted being worn by passengers in the one or more images.
